(19) United States
(12) Patent Application Publication
(10) Pub. No.: US 2025/0093460 A1
(43) Pub. Date: Mar. 20, 2025

(54) SIGNAL PROCESSING DEVICE, SIGNAL PROCESSING METHOD, AND COMPUTER READABLE MEDIUM

(71) Applicant: Mitsubishi Electric Corporation, Tokyo (JP)

(72) Inventor: Shoei NASHIMOTO, Tokyo (JP)

(73) Assignee: Mitsubishi Electric Corporation, Tokyo (JP)

(21) Appl. No.: 18/962,687

(22) Filed: Nov. 27, 2024

Related U.S. Application Data
(63) Continuation of application No. PCT/JP2022/028606, filed on Jul. 25, 2022.

(51) Int. Cl. G01S 7/02; G01S 13/66

(52) U.S. Cl. CPC G01S 7/023; G01S 7/021; G01S 13/66

(57) ABSTRACT

An attack determination unit (241) determines whether or not an attack using a spoofing signal is present by detecting jitter caused by the attack using the spoofing signal from a beat signal (S8). When the jitter has been detected by the attack determination unit (241), a post-countermeasure information calculation unit (242) calculates tracking information (S11) after removing information on a distance and a velocity that are observed due to the spoofing signal. An information selection unit (243) selects tracking information to be used from the tracking information (S11) and tracking information (S9) generated from the beat signal (S8).

### CROSS REFERENCE TO RELATED APPLICATION

This application is a Continuation of PCT International Application No. PCT/JP2022/028606, filed on Jul. 25, 2022, which is hereby expressly incorporated by reference into the present application.

### TECHNICAL FIELD

The present disclosure relates to signal processing of a radar that detects a target object.

### BACKGROUND ART

A radar is a device that measures a relative distance between the radar and a target object and a relative velocity between the radar and the target object by emitting radio waves to the target object and measuring reflected waves from the target object.

The FMCW method is a method of radar measurement. The FMCW method is inexpensive and yet has excellent distance and velocity measurement capabilities. In particular, the fast FMCW method has higher resolution than the conventional slow FMCW method. In the fast FMCW method, the sweep time of a chirp signal is a few microseconds, which is relatively short. FMCW is an abbreviation for frequency modulated continuous wave.

Spoofing attacks while the radar is operated are a threat. A spoofing attack is an attack in which external radio waves that fake measurement are inserted into radio waves of the radar so as to cause the radar to detect an object that does not actually exist.

Non-Patent Literature 1 proposes an attack method that fakes the distance, velocity, and angle of a fast-chirp FMCW radar. For spoofing attacks, an attack device using SDR is used. SDR is an abbreviation for software defined radio.

Non-Patent Literature 2 proposes an attack method that fakes the distance of a slow-chirp FMCW radar. For spoofing attacks, an attack device that combines a radar board with a microcomputer is used. It is also indicated that for an accurate spoofing attack, it is necessary to absorb a synchronization error resulting from individual differences of the radar boards of an attacker and a victim.

### CITATION LIST

### Non-Patent Literature

Non-Patent Literature 1: Zhi Sun, et al. “Who is in control? Practical Physical layer attack and defense for mmWave-based sensing in autonomous vehicles.” IEEE Transactions on Information Forensics and Security 16 (2021): 3199-3214.
Non-Patent Literature 2: Shoei Nashimoto, et al. “Low-cost distance-spoofing attack on FMCW radar and its feasibility study on countermeasure.” Journal of Cryptographic Engineering 11.3 (2021): 289-298.

### SUMMARY OF INVENTION

### Technical Problem

Non-Patent Literature 1 and Non-Patent Literature 2 describe spoofing attack methods. However, Non-Patent Literature 1 and Non-Patent Literature 2 do not describe methods that make it possible to correctly detect a target when a spoofing attack is being carried out.

An object of the present disclosure is to make it possible to correctly detect a target even when a spoofing attack is being carried out.

### Solution to Problem

A signal processing device according to the present disclosure includes
an attack determination unit to determine whether or not an attack using a spoofing signal is present by detecting jitter caused by the attack using the spoofing signal from a beat signal; and
a post-countermeasure information calculation unit to, when the jitter has been detected by the attack determination unit, calculate tracking information after removing information on a distance and a velocity that are observed due to the spoofing signal.

### Advantageous Effects of Invention

In the present disclosure, even when a spoofing attack using a spoofing signal is being carried out, objects can be detected by removing a fake target object generated by the attack. Therefore, it is possible to correctly detect a target even when a spoofing attack is being carried out.

### BRIEF DESCRIPTION OF DRAWINGS

FIG. 1 is a configuration diagram of a radar apparatus 100 according to Embodiment 1;

FIG. 2 is a hardware configuration diagram of a signal processing device 200 according to Embodiment 1;

FIG. 3 is a flowchart illustrating a procedure for the operation of the radar apparatus 100 according to Embodiment 1;

FIG. 4 is a flowchart of a spoofing presence determination process according to Embodiment 1;

FIG. 5 is a figure describing a method for detecting an attack based on a synchronization error due to individual differences in radar according to Embodiment 1;

FIG. 6 is a flowchart of a first attack determination process according to Embodiment 1;

FIG. 7 is a figure describing a method for detecting an attack based on the number of fakes according to Embodiment 1;

FIG. 8 is a flowchart of a second attack determination process according to Embodiment 1;

FIG. 9 is a flowchart of a post-countermeasure information calculation process according to Embodiment 1;

FIG. 10 is a flowchart of a second filtering process according to Embodiment 1;

FIG. 11 is a flowchart of a first filtering process according to Embodiment 1;

FIG. 12 is a flowchart of a second information selection process according to Embodiment 1;

FIG. 13 is a flowchart of the spoofing presence determination process according to Variation 1;

FIG. 14 is a flowchart of the post-countermeasure information calculation process according to Variation 1;

FIG. 15 is a configuration diagram of the radar apparatus 100 according to Variation 2;

FIG. 16 is a flowchart illustrating a procedure for the operation of the radar apparatus 100 according to Variation 2;

FIG. 17 is a flowchart of the post-countermeasure information calculation process according to Variation 2;

FIG. 18 is a flowchart of the second filtering process according to Variation 2;

FIG. 19 is a flowchart of the post-countermeasure information calculation process according to Variation 3;

FIG. 20 is a flowchart of the first filtering process according to Variation 3;

FIG. 21 is a flowchart of the post-countermeasure information calculation process according to Variation 4; and

FIG. 22 is a flowchart of the second filtering process according to Variation 4.

### DESCRIPTION OF EMBODIMENTS

In the embodiment and drawings, the same elements or corresponding elements are denoted by the same reference sign. Description of an element denoted by the same reference sign as that of an element that has been described will be omitted or simplified as appropriate.

Arrows in figures mainly indicate flows of signals, flows of data, or flows of processing. A filled circle is drawn at a branching point where a signal or data flows in a plurality of directions.

### Embodiment 1

### Description of Configuration

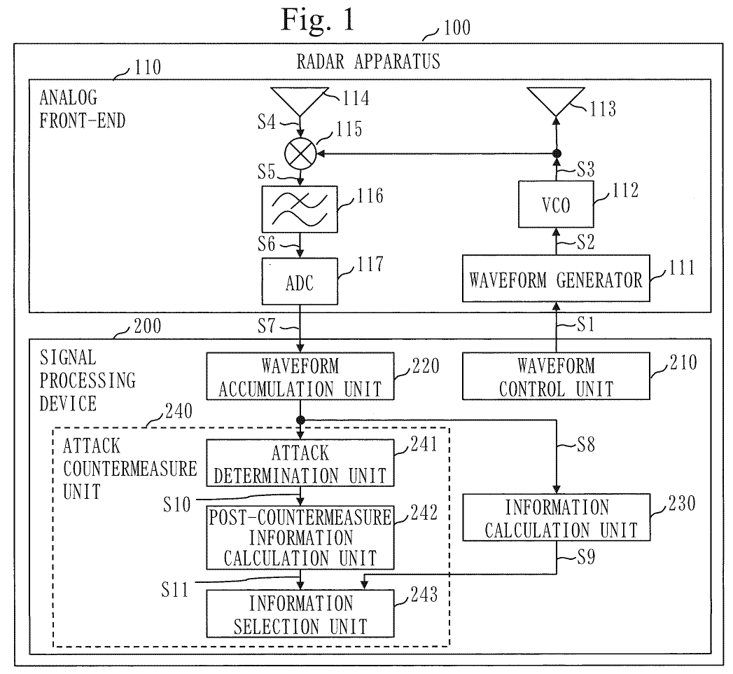

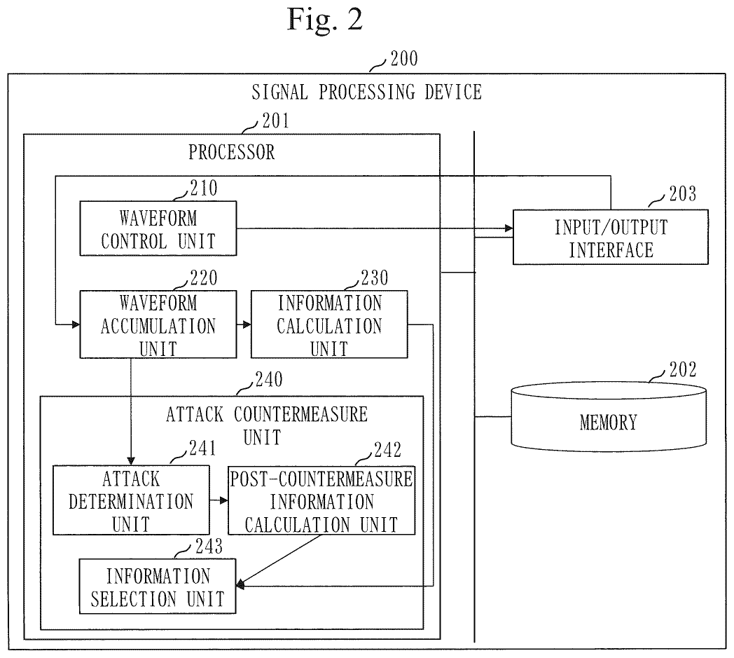

Referring to FIGS. 1 and 2, a configuration of a radar apparatus 100 according to Embodiment 1 will be described.

The radar apparatus 100 calculates the distance, velocity, and angle of a target object by radar measurement and tracks the target object. The target object is a target that is detected by radar measurement. The distance of the target object is the distance from the radar apparatus 100 to the target object. The velocity of the target object is the velocity of the target object relative to the radar apparatus 100. The angle of the target object is the horizontal and vertical angle indicating the location of the target object relative to the radar apparatus 100. Tracking information is a record of time-series changes in the distance, velocity, and angle of the target object.

The radar apparatus 100 includes an analog front-end 110 and a signal processing device 200.

The analog front-end 110 is an analog circuit. The analog front-end 110 includes circuits such as a waveform generator 111, a VCO 112, a transmitting antenna 113, a receiving antenna 114, a mixer 115, a low-pass filter 116, and an ADC 117.

These circuits are connected with each other through signal lines. VCO is an abbreviation for voltage-controlled oscillator. ADC is an abbreviation for analog-to-digital converter.

As illustrated in FIG. 2, the signal processing device 200 is a computer that includes hardware such as a processor 201, a memory 202, and an input/output interface 203. These hardware components are connected with one another through signal lines.

The processor 201 is an IC that performs operational processing and controls other hardware components. For example, the processor 201 is a CPU, a DSP, or a GPU. IC is an abbreviation for integrated circuit. CPU is an abbreviation for central processing unit. DSP is an abbreviation for digital signal processor. GPU is an abbreviation for graphics processing unit.

The memory 202 is at least one of a volatile storage device and a non-volatile storage device. A specific example of the volatile storage device is a RAM. Specific examples of the non-volatile storage device are a ROM, an HDD, and a flash memory. RAM is an abbreviation for random access memory. ROM is an abbreviation for read only memory. HDD is an abbreviation for hard disk drive.

The input/output interface 203 is an interface for input and output. For example, the input/output interface 203 is a serial communication interface. Specific examples of the serial communication interface are SPI, UART, or I2C. SPI is an abbreviation for Serial Peripheral Interface. UART is an abbreviation for universal asynchronous receiver transmitter. I2C is an abbreviation for Inter-Integrated Circuit.

The signal processing device 200 includes, as functional components, a waveform control unit 210, a waveform accumulation unit 220, an information calculation unit 230, and an attack countermeasure unit 240. The attack countermeasure unit 240 includes an attack determination unit 241, a post-countermeasure information calculation unit 242, and an information selection unit 243. The functional components of the signal processing device 200 are realized by software.

The memory 202 stores a signal processing program that realizes the functional components of the signal processing device 200. The signal processing program is executed by the processor 201.

The memory 202 further stores an OS. The OS is executed by the processor 201. The processor 201 executes the signal processing program while executing the OS. OS is an abbreviation for operating system.

Input data and output data of the signal processing program are stored in the memory 202.

The signal processing device 200 may include a plurality of processors as an alternative to the processor 201.

The signal processing program can be recorded (stored) in a computer readable format in a non-volatile recording medium such as an optical disc or a flash memory.

### Description of Operation

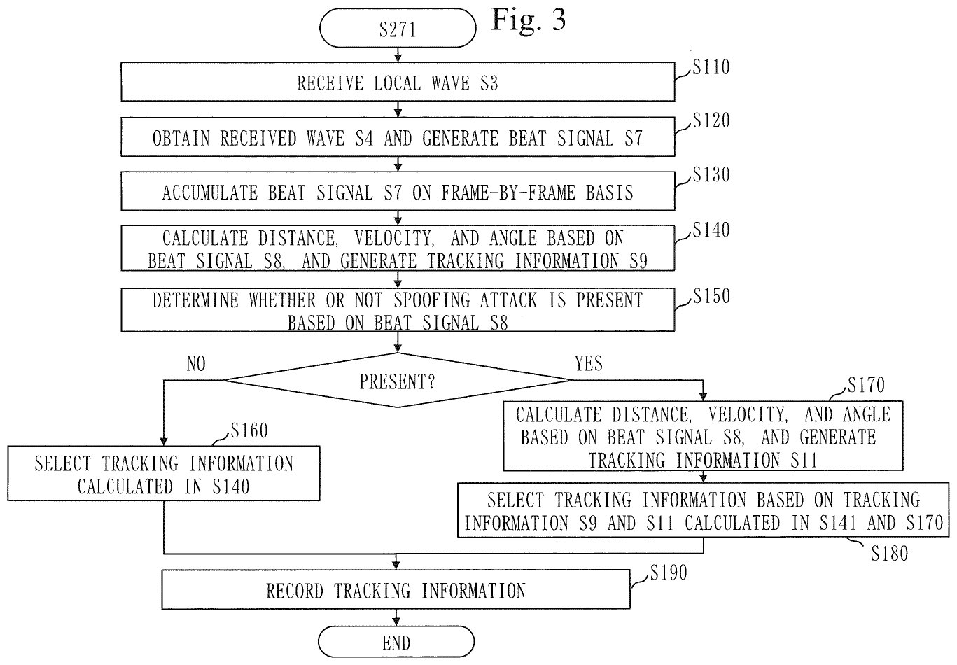

Referring to FIGS. 3 to 12, the operation of the radar apparatus 100 according to Embodiment 1 will be described.

A procedure for the operation of the radar apparatus 100 according to Embodiment 1 is equivalent to a radar operation method. A procedure for the operation of the signal processing device 200 according to Embodiment 1 is equivalent to a signal processing method according to Embodiment 1. The procedure for the operation of the signal processing device 200 according to Embodiment 1 is also equivalent to a procedure for processing by the signal processing program according to Embodiment 1.

Referring to FIG. 3, the procedure for the operation of the radar apparatus 100 according to Embodiment 1 will be described.

### (Step S110: Local Wave Transmission Process)

The analog front-end 110 transmits a local wave S3.

Specifically, the waveform control unit 210 generates a control signal S1, and outputs the generated control signal S1. Based on the control signal S1, the waveform generator 111 outputs a ramp signal S2 to control the VCO 112. The VCO 112 generates the local wave S3 at an oscillation frequency based on the ramp signal S2, and outputs the generated local wave S3.

### (Step S120: Beat Signal Generation Process)

The analog front-end 110 obtains a received wave S4 and generates a beat signal S7.

Specifically, the receiving antenna 114 receives a radio wave as the received wave S4 and outputs the received wave S4 that has been received. The received wave S4 is equivalent to the local wave S3 (radio wave) reflected by the target object or the like. When the radio wave is reflected by the target object, the frequency of the radio wave changes. Therefore, the received wave S4 contains information about a change in frequency resulting from the distance of the target object and the velocity of the target object. When the receiving antenna 114 is composed of a plurality of antennas, each antenna has a phase difference resulting from the angle of the target object.

The mixer 115 performs mixing of the received wave S4 and the local wave S3 input in step S113. Mixing is equivalent to multiplication of signals and can be expressed as Expression 1.

$$cos ( fst ) \cdot cos ( frt ) = [ cos \{ ( fs - fr ) t \} + cos \{ ( fs + fr ) t \} ] / 2 \qquad 〈 Expression 1 〉$$

“fs” represents the frequency of the local wave S3. “fr” represents the frequency of the received wave S4. “cos” represents a cosine function. “t” represents time. “fs” and “fr” typically represent frequencies that change over time. Specifically, “fs” and “fr” represent frequencies corresponding to chirp signals.

A signal generated by this mixing will be referred to as a mixing signal S5. The mixer 115 outputs the mixing signal S5 that has been generated. The mixing signal S5 that has been output is input into the low-pass filter 116.

The low-pass filter 116 filters out components other than low-frequency components of the mixing signal S5. A signal generated by this will be referred to as a filtered signal S6. The filtered signal S6 is equivalent to the low-frequency components extracted from the mixing signal S5. That is, it represents cos {(fs-fr) t} components.

The ADC 117 converts the filtered signal S6, which is an analog signal, into a digital signal. Specifically, the ADC 117 quantizes the filtered signal S6. A digital signal generated by this will be referred to as a beat signal S7.

### (Step S130: Waveform Accumulation Process)

The waveform accumulation unit 220 accumulates the beat signal S7 in the memory 202 on a frame-by-frame basis. The beat signal S7 that has been accumulated is treated as a beat signal S8 on a frame-by-frame basis. Therefore, the beat signal S8 is a signal with dimensions the number of which is sample time x the number of waveforms x the number of antennas.

### (Step S140: Information Calculation Process)

The information calculation unit 230 calculates the distance, velocity, and angle of the target object based on the beat signal S8, and outputs tracking information S9. This is how FMCW radar signals are normally processed.

Specifically, the information calculation unit 230 calculates an RD map by performing 2D-FFT on the beat signal S8, and calculates the distance of the target object and the velocity of the target object. Furthermore, the information calculation unit 230 calculates the angle using an angle estimation algorithm such as a beamformer method. Furthermore, the information calculation unit 230 uses the calculated distance, velocity, and angle information to output tracking information S9 of the target object using a tracking algorithm such as a Kalman filter. 2D-FFT is an abbreviation for 2-dimensional fast Fourier transform. The RD map represents the range-Doppler map. The RD map has dimensions the number of which is range bins x Doppler bins x the number of antennas.

### (Step S150: Spoofing Presence Determination Process)

The attack determination unit 241 determines whether or not a spoofing attack is present based on the beat signal S8, and outputs an attack determination result S10. The details of the process of step S150 will be described later.

If the attack determination result S10 indicates that a spoofing attack is present, processing proceeds to step S170. If the attack determination result S10 indicates that no spoofing attack is present, processing proceeds to step S160.

### (Step S160: First Information Selection Process)

The information selection unit 243 selects the tracking information S9 calculated in step S140.

### (Step S170: Post-Countermeasure Information Calculation Process)

The post-countermeasure information calculation unit 242 calculates the distance, velocity, and angle of the target object based on the attack determination result S10, and outputs tracking information S11. The details of the process of step S170 will be described later.

### (Step S180: Second Information Selection Process)

The information selection unit 243 selects final tracking information based on the tracking information S9 and the tracking information S11. The details of the process of step S180 will be described later.

### (Step S190: Information Recording Process)

The information selection unit 243 records the tracking information in the memory 202. Recording of tracking information is keeping information for a certain period as recorded information. For example, the information selection unit 243 may perform recording in a ring buffer format and use a finite memory to continue holding records for a certain period of time.

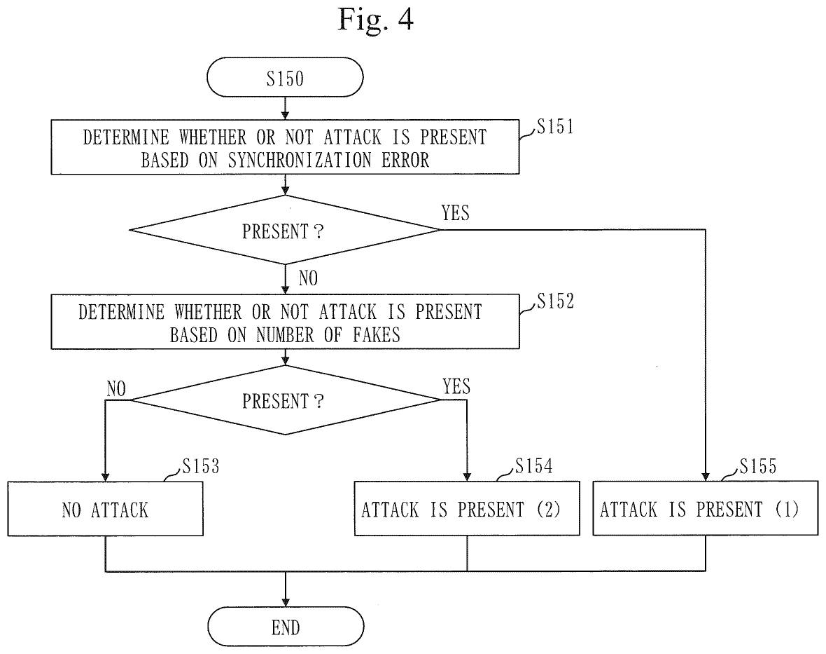

Referring to FIG. 4, the spoofing presence determination process according to Embodiment 1 (step S150 in FIG. 3) will be described.

The attack determination unit 241 determines whether or not a spoofing attack is present by detecting two attack characteristics. One of the attack characteristics is a synchronization error due to individual differences in radar. The other one of the attack characteristics is the number of chirps that have succeeded in spoofing (number of spoofing occurrences).

### (Step S151: First Attack Determination Process)

The attack determination unit 241 determines whether or not an attack using a spoofing signal is present based on a synchronization error due to individual differences in radar. Specifically, the attack determination unit 241 determines whether or not an attack using a spoofing signal is present by detecting jitter caused by a spoofing attack.

If it is determined that an attack is present, processing proceeds to S155 and the attack determination unit 241 determines that an attack is present (1). If it is determined that no attack is present, processing proceeds to S152.

The details of the process of step S151 will be described later.

### (Step S152: Second Attack Determination Process)

The attack determination unit 241 determines whether or not an attack using a spoofing signal is present based on the number of fakes. Specifically, the attack determination unit 241 determines whether or not an attack using a spoofing signal is present by detecting a break in the spoofing signal.

If it is determined that an attack is present, processing proceeds to S154 and the attack determination unit 241 determines that an attack is present (2). If it is determined that no attack is present, processing proceeds to S153 and the attack determination unit 241 determines that no attack is present.

The details of the process of step S152 will be described later.

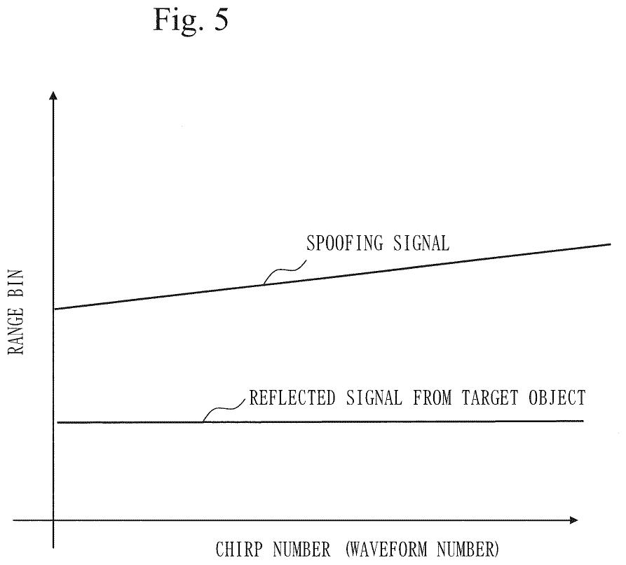

Referring to FIG. 5, a method for detecting an attack based on a synchronization error due to individual differences in radar according to Embodiment 1 will be described.

FIG. 5 indicates waveform-by-waveform changes in frequency with large energy when range-FFT is performed on the beat signal S8. The reflected signal from the target object does not change significantly within one frame even if the target object is moving, so that it looks like a straight line with a slope of 0. On the other hand, in the case of a spoofing signal, a synchronization error appears as a difference in sweep time, so that the distance appears to change gradually in each waveform. Therefore, it appears as a straight line with a slope. Range-FFT represents an operation of performing FFT in a time direction.

The process to detect the above attack characteristic is the first attack determination process (step S151 in FIG. 4).

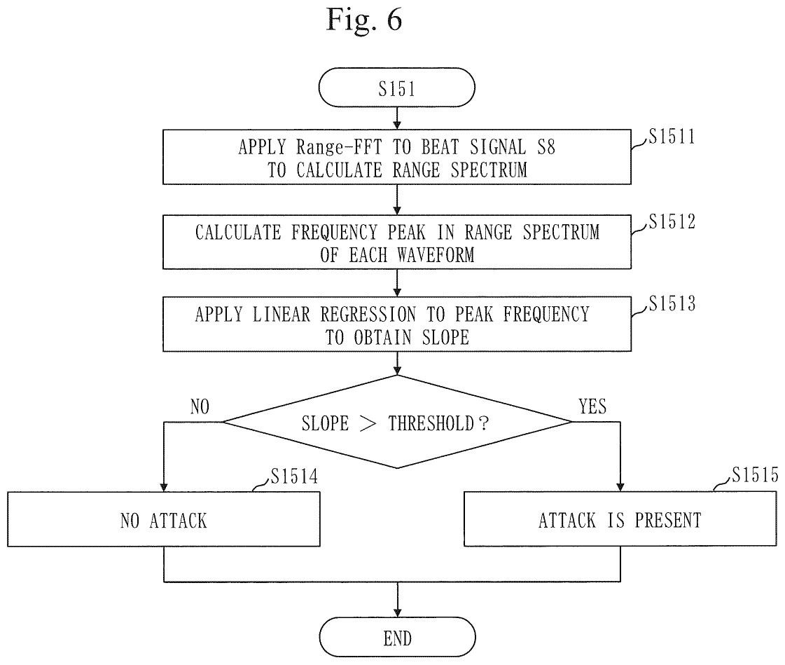

Referring to FIG. 6, the first attack determination process according to Embodiment 1 (step S151 in FIG. 4) will be described.

### (Step S1511: Range Spectrum Calculation Process)

The attack determination unit 241 applies range-FFT to the beat signal S8 to calculate a range spectrum. The calculated range spectrum is a signal with dimensions the number of which is the number of range bins x the number of waveforms.

### (Step S1512: Frequency Peak Calculation Process)

The attack determination unit 241 calculates a frequency peak for each waveform for the range spectrum calculated in step S1511. The frequency peak calculated here appears for the target object or for each spoofing object included in the spoofing signal.

### (Step S1513: Slope Calculation Process)

The attack determination unit 241 applies linear regression to the frequency peak to calculate a slope. If a plurality of frequency peaks are observed, linear regression is applied after clustering them using an algorithm such as DBSCAN.

That is, the attack determination unit 241 calculates a slope that is obtained when the frequency peak of each waveform is expressed as a linear function of a waveform number. In other words, the attack determination unit 241 calculates a slope a by setting the frequency peak as y and the waveform number as x and fitting them into an expression y=ax+b. DBSCAN is an abbreviation for density-based spatial clustering of applications with noise.

If the calculated slope exceeds a slope threshold, that is, if a change in distance is observed over time, processing proceeds to step S1515 and the attack determination unit 241 determines that an attack is present. That is, if the calculated slope exceeds the slope threshold, the attack determination unit 241 acknowledges that jitter caused by a spoofing attack has been detected and determines that an attack is present.

If the slope is equal to or smaller than the slope threshold, processing proceeds to step S1514 and the attack determination unit 241 determines that no attack is present. That is, if the calculated slope is equal to or smaller than the slope threshold, the attack determination unit 241 determines that no jitter caused by a spoofing attack has been detected and determines that no attack is present.

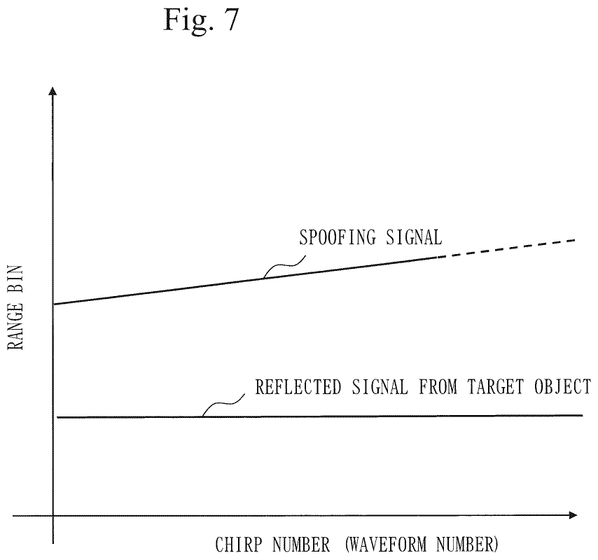

Referring to FIG. 7, a method for detecting an attack based on the number of fakes according to Embodiment 1 will be described.

FIG. 7 indicates waveform-by-waveform changes in frequency with large energy when range-FFT is performed on the beat signal S8 . . . . The reflected signal from the target object is continuously observed in a series of frames. On the other hand, a spoofing signal may fail to fake all chirps and the signal may disappear midway.

Alternatively, the signal may appear from a chirp in the middle.

The process to detect the above attack characteristic is the second attack determination process (step S152 in FIG. 4).

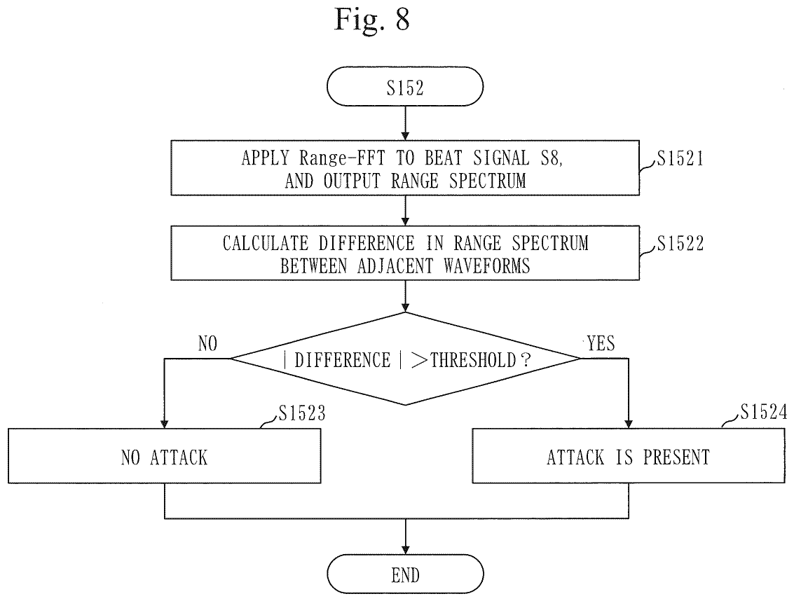

Referring to FIG. 8, the second attack determination process according to Embodiment 1 (step S152 in FIG. 4) will be described.

### (Step S1521: Range Spectrum Calculation Process)

The attack determination unit 241 applies range-FFT to the beat signal S8 to calculate a range spectrum. The calculated range spectrum is a signal with dimensions the number of which is the number of range bins x the number of waveforms x the number of antennas.

### (Step S1522: Difference Calculation Process)

The attack determination unit 241 calculates a difference in range spectrum between adjacent waveforms.

When the calculated range spectrum is expressed as X[range bin][waveform][antenna number], the calculated difference can be expressed as X_DIFF←X[:][i][:]−X[:][i+1][:], where i is an integer of 1 to the number of waveforms−1, and [:] represents all pieces of data of that dimension.

The attack determination unit 241 checks the difference between adjacent spectra for each i of i=1 to the number of waveforms−1, and determines whether the absolute value of the difference exceeds a difference threshold. That is, the attack determination unit 241 observes a large change in the spectrum when a signal suddenly disappears or appears. The attack determination unit 241 determines an attack when a large change is observed.

If the absolute value of the difference exceeds the difference threshold, processing proceeds to step S1524 and the attack determination unit 241 determines that an attack is present. That is, if the absolute value of the difference exceeds the difference threshold, the attack determination unit 241 acknowledges that a break in a spoofing signal has been detected and determines that an attack is present.

If the absolute value of the difference is equal to or smaller than the difference threshold, processing proceeds to S1523 and the attack determination unit 241 determines that no attack is present. That is, if the absolute value of the difference is equal to or smaller than the difference threshold, the attack determination unit 241 acknowledges that no break in a spoofing signal has been detected and determines that no attack is present.

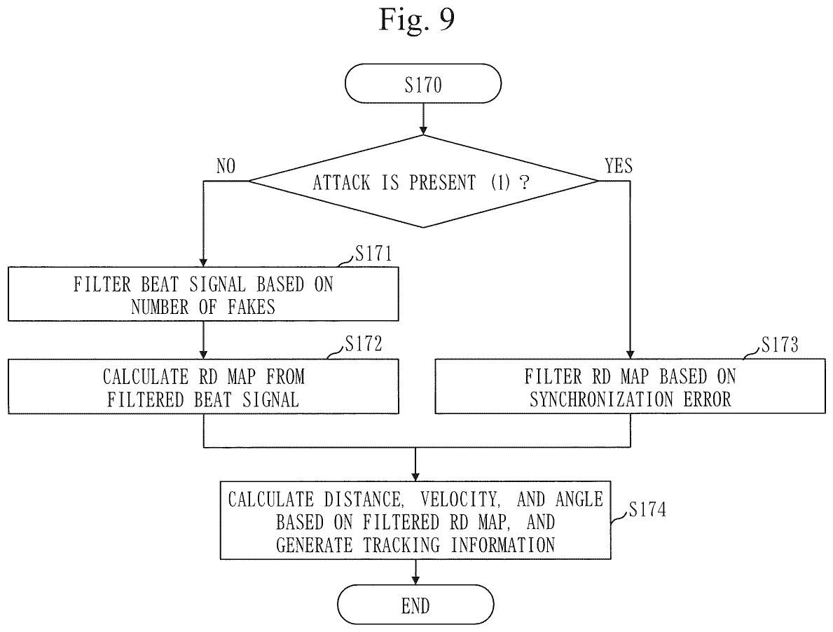

Referring to FIG. 9, the post-countermeasure information calculation process according to Embodiment 1 (step S170 in FIG. 3) will be described.

The attack determination unit 241 detects an attack based on the two types of attack characteristics. Therefore, the post-countermeasure information calculation unit 242 checks which one of the attack characteristics is used to determine that an attack is present. In the case of an attack is present (1), this detection is based on a physical characteristic, so that processing proceeds to step S173.

If an attack is present (1) is not the case, the case of an attack is present (2) is determined. In the case of an attack is present (2), this detection is based on the number of fakes, so that processing proceeds to step S171.

### (Step S171: First Filtering Process)

The post-countermeasure information calculation unit 242 filters the beat signal S8 based on the break in the spoofing signal. The details of the process of step S171 will be described later.

### (Step S172: Map Calculation Process)

The post-countermeasure information calculation unit 242 calculates an RD map from the beat signal S8 filtered in step S171.

### (Step S173: Second Filtering Process)

The post-countermeasure information calculation unit 242 filters the RD map calculated in step S140 based on the synchronization error. The details of the process of step S173 will be described later.

### (Step S174: Information Calculation Process)

The post-countermeasure information calculation unit 242 calculates a distance, a velocity, and an angle based on the RD map obtained in step S172 and step S173, and generates tracking information. The process of generating tracking information from the RD map is the same as the process of step S140 in FIG. 3.

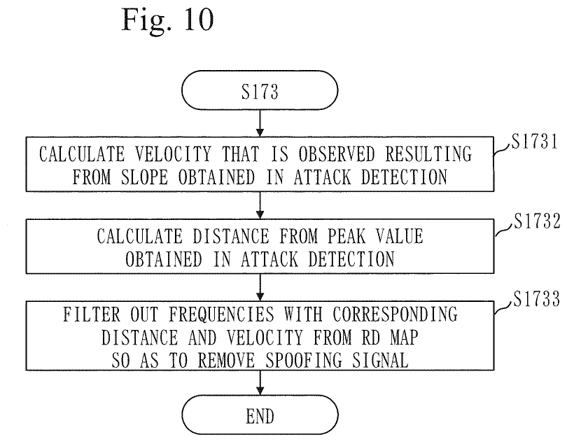

Referring to FIG. 10, the second filtering process according to Embodiment 1 (step S173 in FIG. 9) will be described.

### (Step S1731: Velocity Calculation Process)

The post-countermeasure information calculation unit 242 calculates the velocity that is observed due to the slope calculated in step S1513 in FIG. 6. The time it takes to transmit one chirp is sweep time Ts. That is, the slope is a change in distance per unit time, and is thus the velocity. Here, the post-countermeasure information calculation unit 242 obtains the velocity from the slope a by converting the number of waveforms into time. That is, the post-countermeasure information calculation unit 242 obtains the velocity by a÷Ts. The post-countermeasure information calculation unit 242 converts this velocity into the closest Doppler bin.

### (Step S1732: Distance Calculation Process)

The post-countermeasure information calculation unit 242 calculates the distance from the value of the frequency peak calculated in step S1512 in FIG. 6. That is, the post-countermeasure information calculation unit 242 identifies a range bin that represents the frequency peak resulting from the signal with the above slope.

### (Step S1733: Signal Exclusion Process)

The post-countermeasure information calculation unit 242 excludes frequencies with the range bin and the Doppler bin resulting from the spoofing signal from the RD map calculated in step S140. That is, the post-countermeasure information calculation unit 242 excludes frequencies with the range bin identified in step S1732 and the Doppler bin identified in step S1731 from the RD map calculated in step S140.

For example, the post-countermeasure information calculation unit 242 treats signals near the corresponding range bin and Doppler bin as invalid values. This can be expressed as Expression 2.

$$RD [ R - Rofs : R + Rofs ] [ D - Dofs : D + Dofs ] [ : ] ← N / A \qquad 〈 Expression 2 〉$$

R and D represent the range bin number and the Doppler bin number corresponding to the spoofing signal. Rofs and Dofs represent sizes for filtering out. N/A indicates an invalid value. For example, the minimum value of the RD map may be given as N/A.

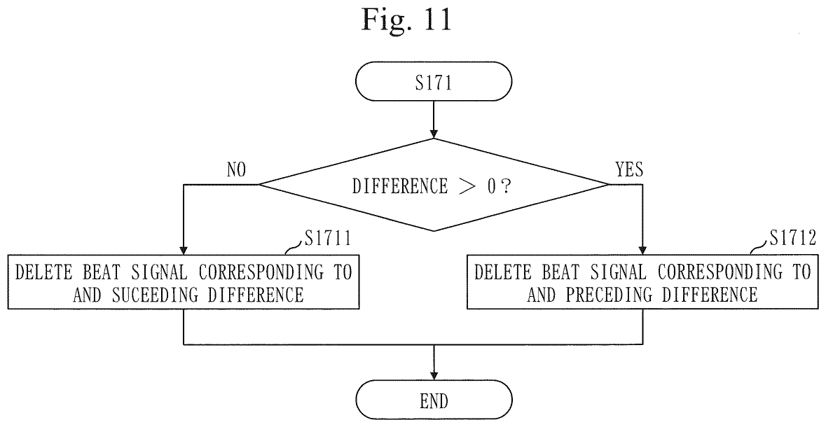

Referring to FIG. 11, the first filtering process according to Embodiment 1 (step S171 in FIG. 9) will be described.

The post-countermeasure information calculation unit 242 re-checks the difference in range spectrum calculated in step S1522 in attack detection, and determines whether the difference is greater than 0. That is, the post-countermeasure information calculation unit 242 checks which one of the old spectrum and the new spectrum in terms of time is larger, thus causing the difference. If the signal disappears in the latter half of the frame as in FIG. 7, the difference becomes greater than 0.

If the difference is greater than 0, processing proceeds to step S1712. If the difference is equal to or smaller than 0, processing proceeds to step S1711.

### (Step S1711: First Deletion Process)

The post-countermeasure information calculation unit 242 deletes, from the beat signal S8, the beat signal corresponding to the waveform number where the difference is observed and its following waveform numbers. That is, the post-countermeasure information calculation unit 242 deletes only the beat signal affected by the attack.

### (Step S1712: Second Deletion Process)

The post-countermeasure information calculation unit 242 deletes, from the beat signal S8, the beat signal corresponding to the waveform number where the difference is observed and its preceding waveform numbers. That is, the post-countermeasure information calculation unit 242 deletes only the beat signal affected by the attack.

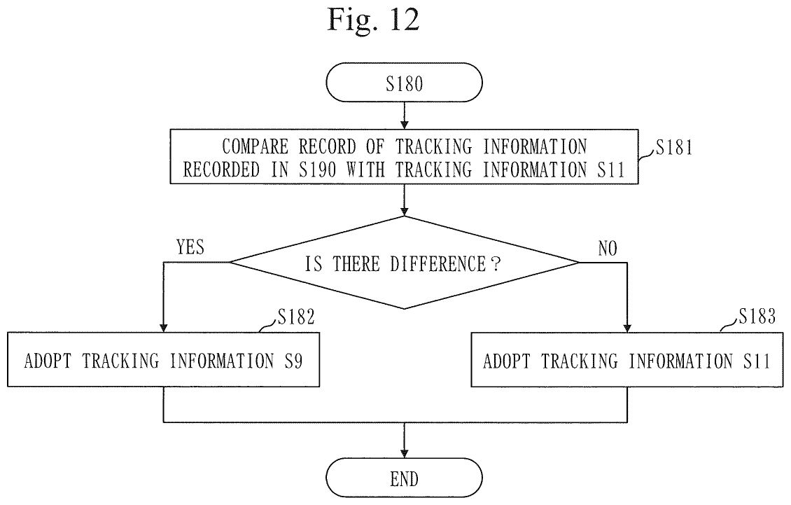

Referring to FIG. 12, the second information selection process according to Embodiment 1 (step S180 in FIG. 3) will be described.

### (Step S181: Record Comparison Process)

The information selection unit 243 compares a record of tracking information previously recorded in step S190 with the tracking information S11 output in step S170. The record of the tracking information previously recorded in step S190 is, for example, the tracking information recorded in step S190 of the preceding time.

If there is a difference, processing proceeds to step S182. If there is no difference, processing proceeds to step S183.

### (Step S182: First Adoption Process)

The information selection unit 243 adopts the tracking information S9. That is, the information selection unit 243 determines that the target object that had been visible has been eliminated by the filtering performed as the countermeasure, and adopts the tracking information S9 calculated directly from the beat signal S8 without applying the countermeasure.

### (Step S183: Second Adoption Process)

The information selection unit 243 adopts the tracking information S11. That is, the information selection unit 243 determines that the spoofing signal that had not been present has been successfully eliminated by the filtering performed as the countermeasure, and adopts the tracking information S11 calculated by applying the countermeasure.

### Effects of Embodiment 1

As described above, the signal processing device 200 according to Embodiment 1 devises signal processing to extract information from a beat signal within the framework of the conventional FMCW method.

Specifically, the information calculation unit 230 calculates the tracking information S9 based on the beat signal S8 on a frame-by-frame basis. At the same time, the attack determination unit 241 performs an attack determination based on the beat signal S8 on a frame-by-frame basis, and generates the attack determination result S10. Based on the attack determination result S10, the post-countermeasure information calculation unit 242 generates a filtered RD map, excludes the spoofing signal, and then calculates the tracking information S11. The information selection unit 243 detects an attack that exploits a countermeasure by using the tracking information S9 and the tracking information S11, which are calculated by two different methods depending on whether or not the countermeasure is applied, and referring to a past tracking information record, and outputs appropriate tracking information.

The attack determination unit 241 detects an attack by utilizing a synchronization error due to individual differences in radar that exists in an attack using a spoofing signal, or a possibility that faking an entire frame may fail. If an attack is detected, the post-countermeasure information calculation unit 242 removes the spoofing signal from the RD map. That is, it is possible to detect and counter a spoofing attack.

The information selection unit 243 determines whether there is a target object that has existed in a previous tracking information record but disappears after applying the countermeasure, and outputs appropriate tracking information. That is, it is possible to detect and counter an attack that exploits filtering as a countermeasure so as to remove an existing target object.

### Other Configurations

### <Variation 1>

As Variation 1, only detection based on a synchronization error may be performed.

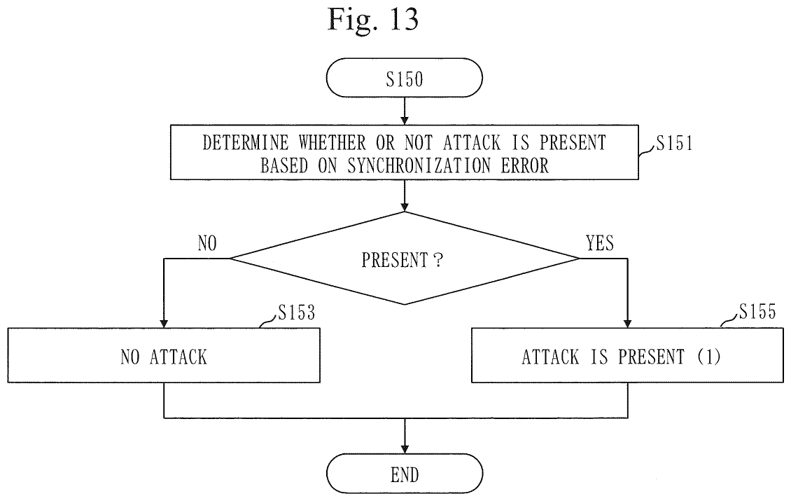

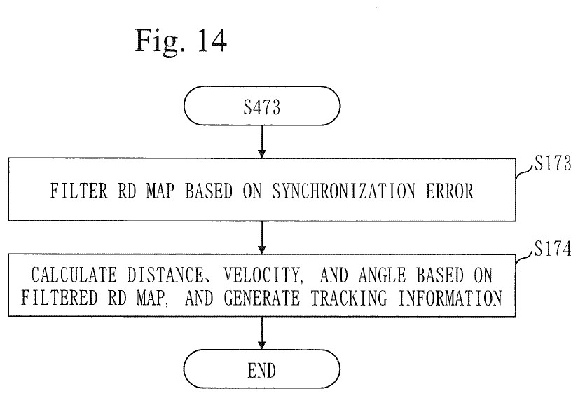

The configuration of the radar apparatus 100 according to Variation 1 is as illustrated in FIG. 1. FIG. 13 represents the spoofing presence determination process according to Variation 1 (step S150 of FIG. 3). The radar apparatus 100 according to Variation 1 determines whether or not an attack is present based on a synchronization error. Accordingly, as indicated in FIG. 14, only the process of filtering the RD map based on a synchronization error is performed in the post-countermeasure information calculation process (step S170 in FIG. 3).

### <Variation 2>

As Variation 2, if an attack is detected based on a synchronization error, information resulting from a spoofing signal may be excluded from tracking information.

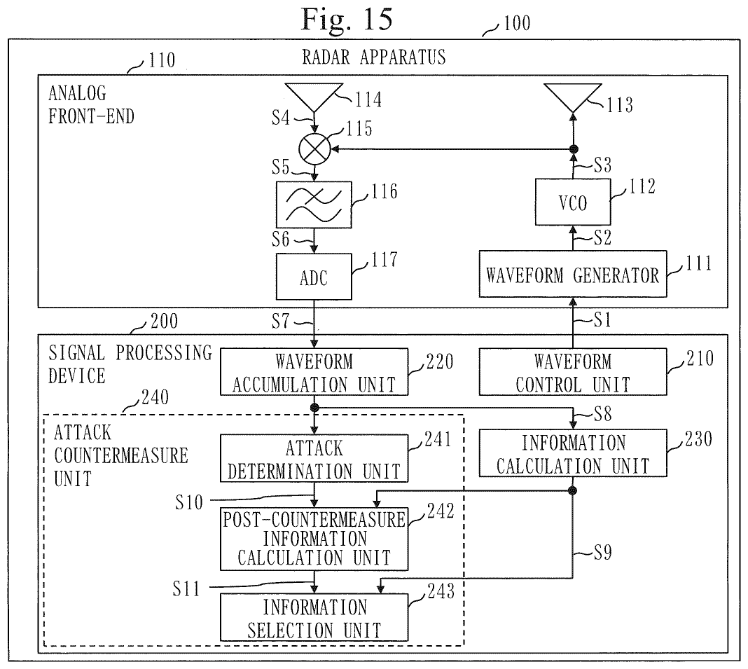

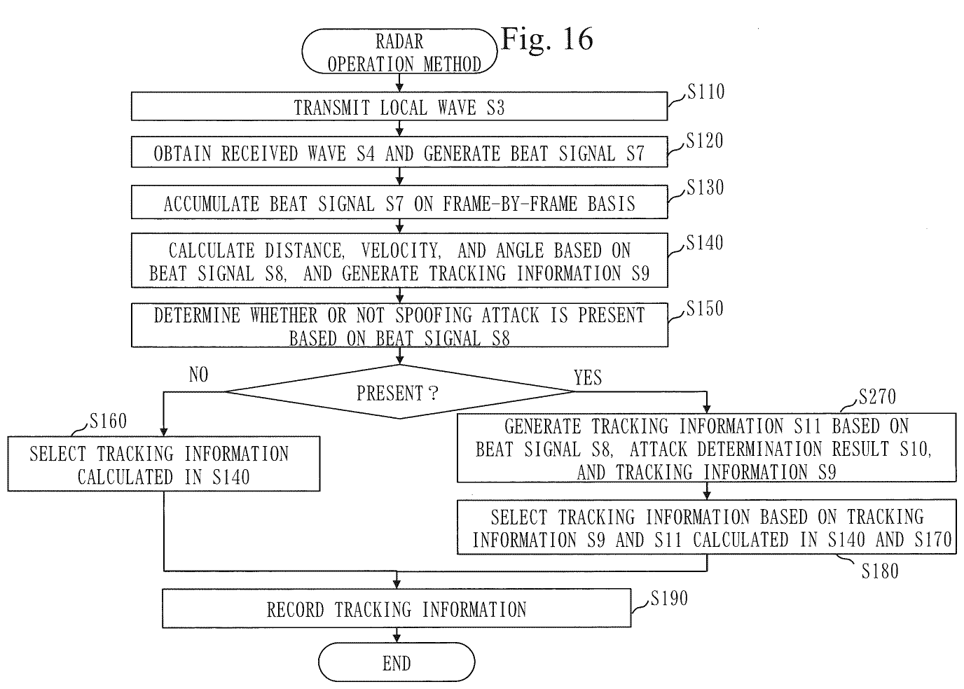

FIG. 15 illustrates a configuration of the radar apparatus 100 according to Variation 2. A difference from FIG. 1 is that the tracking information S9 is given as input to the post-countermeasure information calculation unit 242. Accordingly, the procedure for the operation of the radar apparatus 100 is changed as indicated in FIG. 16. In FIG. 16, the process of step S170 in FIG. 3 is changed to the process of step S270. In step S270, the post-countermeasure information calculation unit 242 generates the tracking information S11 based on the beat signal S8, the attack determination result S10, and the tracking information S9.

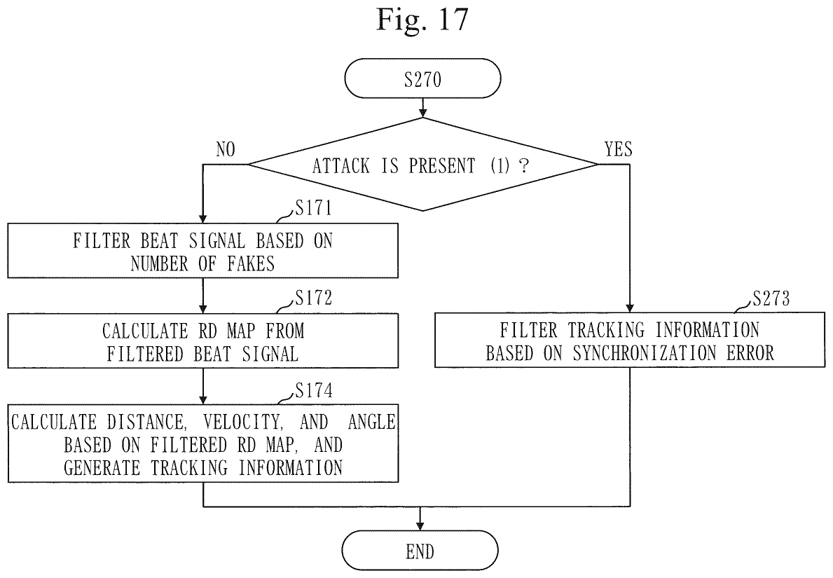

Referring to FIG. 17, the post-countermeasure information calculation process according to Variation 2 (step S270 in FIG. 16) will be described.

The processes of step S171 to step S172 and step S174 are the same as those in the post-countermeasure information calculation process according to Embodiment 1 (step S170 in FIG. 3). In step S273, the post-countermeasure information calculation unit 242 filters the tracking information based on a synchronization error.

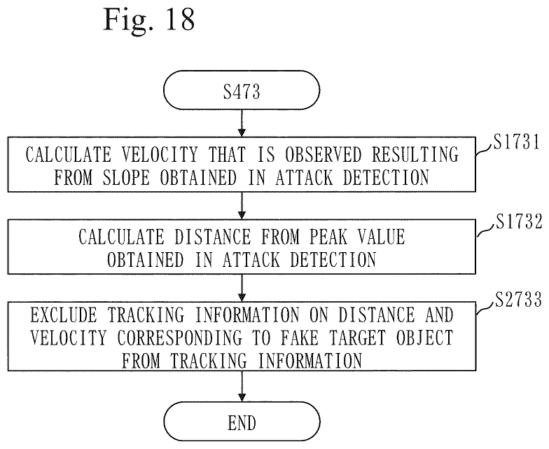

Referring to FIG. 18, the second filtering process according to Variation 2 (step S273 in FIG. 17) will be described.

The processes of step S1731 to step S1732 are the same as those in the second filtering process according to Embodiment 1 (step S173 in FIG. 9).

In step S2733, the post-countermeasure information calculation unit 242 excludes tracking information on the distance and velocity corresponding to the detected spoofing signal from the tracking information S9. For example, when the distance, velocity, and angle are used as tracking information, the post-countermeasure information calculation unit 242 excludes all pieces of tracking information in which a match in the distance and velocity is found.

### <Variation 3>

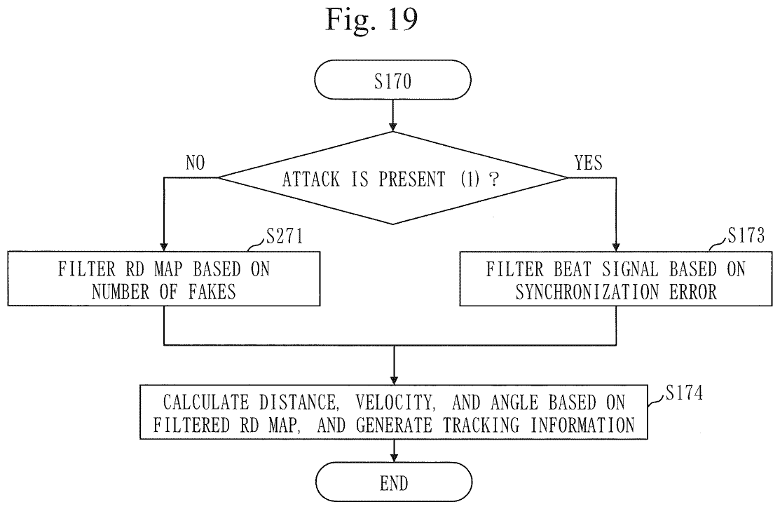

As Variation 3, the RD map may be filtered also when an attack is detected based on the number of fakes. FIG. 19 represents the post-countermeasure information calculation process according to Variation 3 (step S170 in FIG. 3). The processes of step S173 to step S174 are the same as those in the post-countermeasure information calculation process according to Embodiment 1 (step S170 in FIG. 3). In step S271, the post-countermeasure information calculation unit 242 filters the RD map calculated in step S140 based on the break in the spoofing signal.

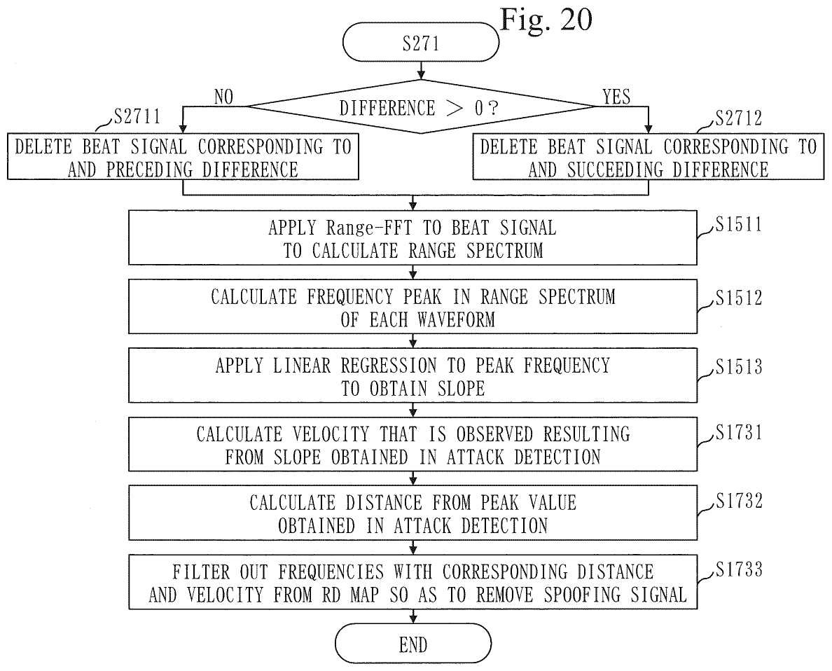

Referring to FIG. 20, the first filtering process according to Variation 3 (step S271 in FIG. 19) will be described.

First, as in step S171, the difference in range spectrum calculated in step S1522 in attack detection is re-checked to determine whether the difference is greater than 0. If the difference is greater than 0, processing proceeds to step S2712. If the difference is equal to or smaller than 0, processing proceeds to step S2711.

### (Step S2711: First Deletion Process)

The post-countermeasure information calculation unit 242 deletes, from the beat signal S8, the beat signal corresponding to the waveform number where the difference is observed and its preceding waveform numbers. That is, the post-countermeasure information calculation unit 242 deletes only the beat signal not affected by the attack. This operation is a process in which the signal that is deleted is reversed in relation to step S1711.

### (Step S2712: Second Deletion Process)

The post-countermeasure information calculation unit 242 deletes, from the beat signal S8, the beat signal corresponding to the waveform number where the difference is observed and its succeeding waveform numbers. That is, the post-countermeasure information calculation unit 242 deletes only the beat signal not affected by the attack. This operation is a process in which the signal that is deleted is reversed in relation to step S1712.

The subsequent processes are the same as the processes of step S151 and step S173. That is, the post-countermeasure information calculation unit 242 calculates the distance and velocity corresponding to the spoofing signal based on a change in distance, and filters out corresponding frequencies from the RD map.

### <Variation 4>

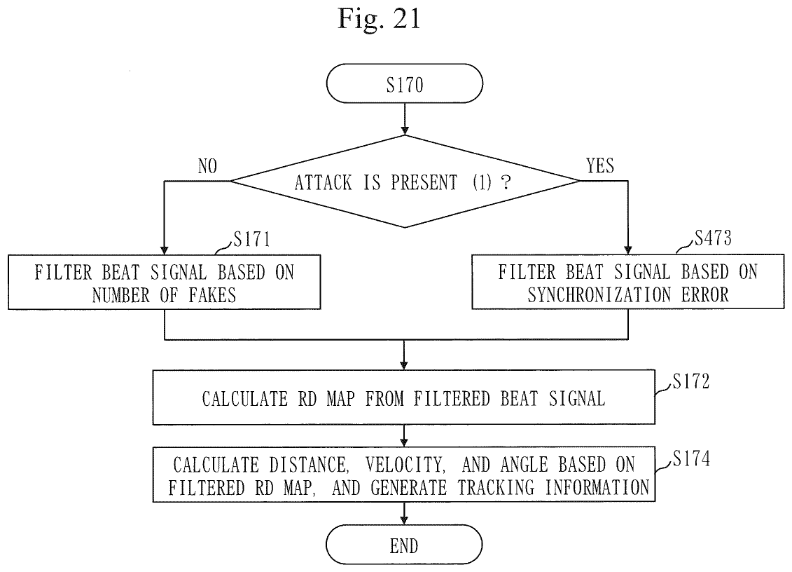

As Variation 4, the beat signal may be filtered also when an attack is detected based on a synchronization error. FIG. 21 represents the post-countermeasure information calculation process according to Variation 4 (step S170 in FIG. 3). The processes of step S171 to step S172 and the process of step S174 are the same as those in the post-countermeasure information calculation process according to Embodiment 1 (step 170 in FIG. 3). In step S473, the post-countermeasure information calculation unit 242 filters the beat signal S8 based on the synchronization error.

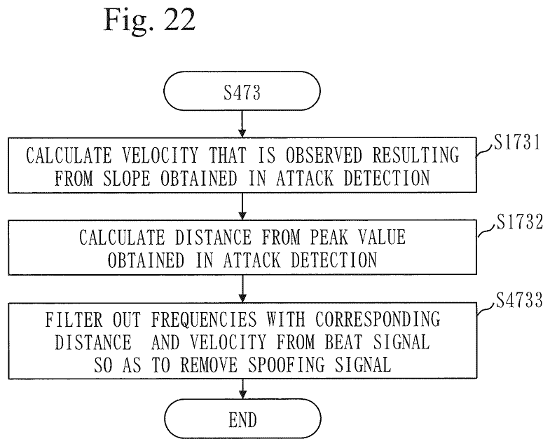

Referring to FIG. 22, the second filtering process according to Variation 4 (step S473 in FIG. 21) will be described.

The processes of step S1731 to step S1732 are the same as those in the second filtering process according to Embodiment 1 (step S173 in FIG. 9). In step S4733, the post-countermeasure information calculation unit 242 filters out and excludes frequencies of the distance and velocity corresponding to the spoofing signal from the beat signal. For example, the post-countermeasure information calculation unit 242 uses a notch filter to filter out frequencies with the range bin corresponding to the spoofing signal in a sampling time direction, and uses a notch filter to filter out frequencies with the Doppler bin corresponding to the spoofing signal in a waveform direction.

### <Variation 5>

In Embodiment 1, the functional components are realized by software.

However, as Variation 5, the functional components may be realized by hardware. With regard to this Variation 5, differences from Embodiment 1 will be described.

When the functional components are realized by hardware, the signal processing device 200 includes an electronic circuit in place of the processor 201 and the memory 202. The electronic circuit is a dedicated circuit that realizes the functions of the functional components and the memory 202.

The electronic circuit is assumed to be a single circuit, a composite circuit, a programmed processor, a parallel-programmed processor, a logic IC, a GA, an ASIC, or an FPGA. GA is an abbreviation for gate array. ASIC is an abbreviation for application specific integrated circuit. FPGA is an abbreviation for field-programmable gate array.

The functional components may be realized by one electronic circuit, or the functional components may be distributed to and realized by a plurality of electronic circuits.

### <Variation 6>

As Variation 6, some of the functional components may be realized by hardware, and the rest of the functional components may be realized by software.

Each of the processor 201, the memory 202, and the electronic circuit is referred to as processing circuitry. That is, the functions of the functional components are realized by the processing circuitry.

“Unit” in the above description may be interpreted as “circuit”, “step”, “procedure”, “process”, or “processing circuitry”.

The embodiment and variations of the present disclosure have been described above. Two or more of these embodiment and variations may be implemented in combination. Alternatively, one of them or two or more of them may be partially implemented. The present disclosure is not limited to the above embodiment and variations, and various modifications can be made as necessary. For example, a multi-input multi-output (MIMO) radar with a plurality of transmitting antennas 113 and a plurality of receiving antennas 114 may be implemented. In that case, there may be the same number of low-pass filters 116 and ADCs 117 as the number of receiving antennas 114.

### REFERENCE SIGNS LIST

100: radar apparatus, 110: analog front-end, 111: waveform generator, 112: VCO, 113: transmitting antenna, 114: receiving antenna, 115: mixer, 116: low-pass filter, 117: ADC, 200: signal processing device, 201: processor, 202: memory, 203: input/output interface, 210: waveform control unit, 220: waveform accumulation unit, 230: information calculation unit, 240: attack countermeasure unit, 241: attack determination unit, 242: post-countermeasure information calculation unit, 243: information selection unit.

1. A signal processing device comprising
processing circuitry to:
determine whether or not an attack using a spoofing signal is present by detecting jitter caused by the attack using the spoofing signal from a beat signal; and
calculate, when the jitter has been detected, tracking information after removing information on a distance and a velocity that are observed due to the spoofing signal,
wherein the processing circuitry acknowledges that the jitter has been detected when a slope exceeds a slope threshold, the slope being obtained by representing a frequency peak of each waveform in a range spectrum of the beat signal by a linear function of a waveform number.

2. The signal processing device according to claim 1,
wherein when the jitter has been detected, the processing circuitry calculates the tracking information after removing information on a distance and a velocity that are observed due to the spoofing signal from a range-Doppler (RD) map generated from the beat signal, or excludes a target object with a distance and a velocity that are observed due to the spoofing signal from tracking information generated from the beat signal.

3. The signal processing device according to claim 1,
wherein when the jitter has been detected, the processing circuitry calculates the tracking information after removing information on a distance and a velocity that are observed due to the spoofing signal from the beat signal.

4. The signal processing device according to claim 1,
wherein the processing circuitry refers to a record of tracking information, and selects tracking information to be adopted from tracking information calculated by the processing circuitry and tracking information calculated directly from the beat signal.

5. The signal processing device according to claim 4,
wherein the processing circuitry selects the tracking information calculated directly from the beat signal when a target object that exists in the record of tracking information does not exist in the tracking information calculated by the processing circuitry.

6. A signal processing method comprising:
determining whether or not an attack using a spoofing signal is present by detecting jitter caused by the attack using the spoofing signal from a beat signal;
calculating, when the jitter has been detected, tracking information after removing information on a distance and a velocity that are observed due to the spoofing signal; and
acknowledging that the jitter has been detected when a slope exceeds a slope threshold, the slope being obtained by representing a frequency peak of each waveform in a range spectrum of the beat signal by a linear function of a waveform number.

7. A non-transitory computer readable medium storing a signal processing program that causes a computer to function as a signal processing device to perform:
an attack determination process of determining whether or not an attack using a spoofing signal is present by detecting jitter caused by the attack using the spoofing signal from a beat signal; and
a post-countermeasure information calculation process of, when the jitter has been detected by the attack determination process, calculating tracking information after removing information on a distance and a velocity that are observed due to the spoofing signal,
wherein in the attack determination process, it is acknowledged that the jitter has been detected when a slope exceeds a slope threshold, the slope being obtained by representing a frequency peak of each waveform in a range spectrum of the beat signal by a linear function of a waveform number.
